(19) United States
(12) Patent Application Publication
(10) Pub. No.: US 2005/0220048 A1
(43) Pub. Date: Oct. 6, 2005

(54) Internet connection service method, system, and medium for mobile nodes

(75) Inventors: Min-ho Lee, Seoul (KR); Pyung-soo Kim, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/094,691

(22) Filed: Mar. 31, 2005

(30) Foreign Application Priority Data
Apr. 2, 2004 (KR) 10-2004-0022884

(51) Int. Cl. H04B 7/00

(52) U.S. Cl. 370/328

(57) ABSTRACT

An Internet connection service method, system, and medium used with mobile nodes. The Internet connection service method, system, and medium can switch a mobile node between network service areas having different extended service set identifiers (ESSIDs) by simplifying a process of re-authenticating a mobile node. The Internet connection service method includes: receiving an inter-access point protocol (IAPP) message containing authentication information on the mobile node from an access point (AP) of a network service area, to which the mobile node currently belongs; and transmitting the IAPP message to an AP of at least one network service area having different identification information from the network service area, to which the mobile node currently belongs.

### CROSS-REFERENCE TO RELATED APPLICATIONS

This application claims the benefit of Korean Patent Application No. 10-2004-0022884, filed on Apr. 2, 2004, in the Korean Intellectual Property Office, the disclosure of which is incorporated herein in its entirety by reference.

### BACKGROUND OF THE INVENTION

1. Field of the Invention

The present invention relates to an Internet connection service for mobile nodes, and more particularly, to an Internet connection service method and system for mobile nodes, which can switch a mobile node from a first network service area to a second network service area having a different extended service set identifier (ESSID) from the first network service area when the mobile node moves from the first network service area to the second network service area.

2. Description of the Related Art

Mobile nodes, i.e., mobile terminals, enable users to access the Internet and use various Internet services. The mobile nodes include laptop computers, web pads, hand-held PCs, personal digital assistants (PDAs), cellular phones, and so on.

The mobile nodes can maintain a session for an Internet service by using a mobile Internet protocol (IP) even when moving between network service areas having different ESSIDs. Examples of network service areas may be wireless LAN service areas, or a wireless LAN service area and a cellular network service area. Examples of cellular network service area may be a code division multiple access (CDMA) network, which has been adopted in the United States and Korea, a generalized packet radio service (GPRS) network, which has been adopted in Europe, or a wide-band CDMA network.

The network service areas may be connected to each other by one Internet service provider so that the mobile nodes can seamlessly use Internet services even when moving therebetween.

However, there are some Internet services that require the mobile nodes to be properly authenticated. In order to effectively use these Internet services while moving between network service areas having different ESSIDs, the mobile nodes should access an authorization authentication accounting (AAA) server on the Internet and then perform authorization, authentication, and accounting processes (hereinafter, referred to as AAA processes) whenever they encounter a new network service area.

For example, when a mobile node uses an Internet service that requires the mobile node to be properly authenticated in a wireless LAN service area having an ESSID e1 and then moves to a mobile LAN service area having an ESSID e2, the mobile node should access the AAA server and then perform the AAA processes that it has already performed when entering the wireless LAN service area having the ESSID e1 in order to maintain a session for the Internet service, even in the wireless LAN service area having the ESSID e2. In addition, when the mobile node moves from a wireless LAN service area to a mobile communications network service area or vice versa, the mobile node should perform the AAA processes that it has already performed when entering the wireless LAN service area or the mobile communications network service area in order to maintain a session for the Internet service.

In short, whenever a mobile node moves from one network service area to another while using an Internet service, the mobile node may have to perform the AAA processes all over again, which results in an overload on the AAA server. In addition, an entire process of switching the mobile node from one network service area to another may become complicated, and the speed of switching the mobile node from one network service area to another may decrease because the mobile node performs the AAA processes whenever it encounters a new network service area. As a result, it may take a considerable amount of time for the mobile node to bicast data, which results in a decrease in the efficiency of a network and may cause discontinuity in an Internet service.

### SUMMARY OF THE INVENTION

Exemplary embodiments of the present invention may provide an Internet access service method and system for mobile nodes, which can quickly switch a mobile node between network service areas having different ESSIDs by simplifying a process of re-authenticating a mobile node when the mobile node moves from one network service area to another.

Exemplary embodiments of the present invention also may provide an Internet access service method and system for mobile nodes, which can quickly switch a mobile node between network service areas that are connected to one another by one Internet service provider (ISP) but have different ESSIDs by allowing APs in the network service areas to share authentication information on the mobile node.

Additional aspects and/or advantages of the invention will be set forth in part in the description which follows and, in part, will be apparent from the description, or may be learned by practice of the invention.

To achieve the above and/or other aspects and advantages, exemplary embodiments of the present invention may include an Internet connection service method for a mobile node including the operations of receiving an inter-access point protocol (IAPP) message containing authentication information on the mobile node from an access point (AP) of a network service area, to which the mobile node currently belongs; and transmitting the IAPP message to an AP of at least one network service area having different identification information from the network service area, to which the mobile node currently belongs.

The APs may be representative APs of their respective network service areas.

If any of the network service areas are mobile communications network service areas, the representative APs of the mobile communications network service areas may have virtual APs.

The network service areas may be wireless LAN service areas or mobile communications network service areas.

The network service areas may be connected to each other by one Internet service provider (ISP).

The IAPP message from the mobile node may be received by an IAPP mobility agent server, and the IAPP mobility agent server may transmit the IAPP message to the AP of at least one network service area having the different identification information from the network service area, to which the mobile node currently belongs.

To achieve the above and/or other aspects and advantages, exemplary embodiments of the present invention may include an Internet connection service method for a mobile node including the operations of enabling a representative AP of a first network service area to transmit an inter-AP protocol message (IAPP) message containing authentication information on the mobile node to an IAPP mobility agent server on the Internet if the mobile node is connected to the first network service area; enabling the IAPP mobility agent server to transmit the IAPP message to a representative AP of at least one network service area having different identification information from the first network service area; enabling the representative AP of the at least one network service area to multicast the IAPP message to at least one AP in the at least one network service area; and enabling a first AP in a second network service area among the at least one network service area to perform an authentication process on the mobile node by referring to the IAPP message and to connect the mobile node to the Internet if the mobile node moves to a service area managed by the first AP.

The first network service area and the at least one network service area may be wireless LAN service areas or mobile communications network service areas.

The first network service area and the at least one network service area may be connected to each other by an ISP.

To achieve the above and/or other aspects and advantages, exemplary embodiments of the present invention may include an IAPP mobility agent server used in an Internet connection service system for a mobile node. The IAPP mobility agent server includes a processing module, which enables APs in wireless LAN service areas and/or mobile communication service areas having different identification information to share an IAPP message containing authentication information on the mobile node, the wireless LAN service areas and/or the mobile communication service areas are connected to one another by an ISP.

The IAPP mobility agent server may also include a first storage unit, which stores Internet protocol (IP) addresses of the APs. Here, the APs are representative APs of their respective network service areas.

The IAPP mobility agent server may also include a second storage unit, which stores the authentication information on the mobile node, included in the IAPP message.

The IAPP mobility agent server may also include a second storage unit, which stores the authentication information on the mobile node, included in the IAPP message.

The authentication information on the mobile node, which is stored in the second storage unit, may be updated whenever the mobile node completes its association with the Internet.

To achieve the above and/or other aspects and advantages, exemplary embodiments of the present invention may include a mobile communication base station used in an Internet connection service system for a mobile node. The mobile communication base station includes a virtual AP, which is connected to the Internet via a packet data service node (PDSN) and performs an inter-AP protocol operation, the PDSN being connected to a mobile communications network; a base transceiver station, which is wirelessly connected to the mobile node; and a communication controller, which obtains authentication information on the mobile node from the virtual AP, and then provides the authentication information on the mobile node to the base transceiver station if the base transceiver station issues a request for the authentication information on the mobile node.

The base transceiver station may determine whether to perform an authentication process on the mobile node based on information transmitted from the communication controller in response to the request for the authentication information on the mobile node.

When the mobile node is connected to the base transceiver station, the virtual AP may transmit an IAPP message containing the authentication information on the mobile node to the PDSN.

To achieve the above and/or other aspects and advantages, exemplary embodiments of the present invention may include a mobile communication base station used in an Internet connection service system for a mobile node. The mobile communication base station includes a virtual AP, which is installed in a PDSN and performs an inter-AP protocol operation by using the Internet; a base transceiver station, which is wirelessly connected to the mobile node; and a communication controller, which obtains authentication information on the mobile node from the virtual AP and then provides the authentication information on the mobile node to the base transceiver station if the base transceiver station issues a request for the authentication information on the mobile node.

To achieve the above and/or other aspects and advantages, exemplary embodiments of the present invention may include an Internet connection service system for mobile nodes including a first AP, which transmits an inter-AP protocol (IAPP) message to the Internet if a mobile node is connected to the Internet in a first network service area; a second AP, which has a different extended service set identifier (ESSID) from the first AP, receives and stores the IAPP message, and performs an authentication process on the mobile node by referring to the IAPP message stored therein if the mobile node moves to a second network service area; and an IAPP mobility agent server, which receives the IAPP message from the first AP and then transmits the IAPP message to a representative AP of at least one network service area other than the first network service area.

The first and second APs may be representative APs of the first and second network service areas.

At least one computer readable medium storing instructions that control at least one processor to perform operations including receiving an inter-access point protocol (IAPP) message including authentication information on the mobile node from an access point (AP) of a network service area, to which the mobile node currently belongs; and transmitting the IAPP message to an AP of at least one network service area having different identification information from the network service area, to which the mobile node currently belongs.

The APs are representative APs of their respective network service areas. If any of the network service areas are mobile communications network service areas, the representative APs of the mobile communications network service areas are virtual APs.

The network service areas are wireless LAN service areas or mobile communications network service areas.

The network service areas are connected to each other by one Internet service provider (ISP).

At least one computer readable medium storing instructions that control at least one processor to perform a operations including enabling a representative access point (AP) of a first network service area to transmit an inter-AP protocol message (IAPP) message containing authentication information on the mobile node to an IAPP mobility agent server on the Internet if the mobile node is connected to the first network service area; enabling the IAPP mobility agent server to transmit the IAPP message to a representative AP of at least one network service area having different identification information from the first network service area; enabling the representative AP of the at least one network service area to multicast the IAPP message to at least one AP in the at least one network service area; and enabling a first AP in a second network service area among the at least one network service area to perform an authentication process on the mobile node by referring to the IAPP message and to connect the mobile node to the Internet if the mobile node moves to a service area managed by the first AP.

The first network service area and the at least one network service area are wireless LAN service areas or mobile communications network service areas.

The first network service area and the at least one network service area are connected to each other by an ISP.

A network for connecting a mobile node to the network, including an authorization, authentication, and accounting (AAA) server coupled to the Internet; an inter-access point protocol (IAPP) mobility agent server coupled to the Internet; and a plurality of network service areas coupled to the Internet, wherein: the mobile node initiates a request for access to the Internet through a first network service area, which accesses the AAA server through the Internet, the AAA server processes the request and permits the mobile node to connect to the Internet; the first network service area transmits an IAPP message providing information on the mobile node to the IAPP mobility agent server; the mobile node moves from the first network service area to a second network service area with uninterrupted access to the Internet, and without accessing the AAA server.

The second network service area transmits another IAPP message providing updated information on the mobile node to the IAPP mobility agent server.

The first network service area is a wireless local area network (LAN) service area or a mobile communication base station. The second network service area is a wireless LAN service area or a mobile communication base station.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram illustrating an exemplary embodiment of a network including an Internet access service system for mobile nodes according to an exemplary embodiment of the present invention;

FIG. 2 is a detailed block diagram of an exemplary embodiment of an inter-AP protocol (IAPP) mobility agent server in the Internet access service system of FIG. 1;

FIG. 3 is a diagram illustrating an exemplary transmission of an IAPP message between wireless LAN service areas in the Internet access service system of FIG. 1;

FIG. 4 is a diagram illustrating an exemplary embodiment of a network including an Internet access service system for mobile nodes according to another exemplary embodiment of the present invention;

FIG. 5 is a detailed block diagram of an exemplary embodiment of a mobile communication base station in the Internet access service system of FIG. 4;

FIG. 6 is a diagram illustrating an exemplary transmission of an IAPP message between a wireless LAN service area and a mobile communications network service area in the Internet access service system of FIG. 4;

FIG. 7 is a diagram illustrating an exemplary transmission of an IAPP message between the wireless LAN service area and a mobile communications network service area in the Internet access service system of FIG. 4; and

FIG. 8 is a diagram illustrating an exemplary transmission of an IAPP message between the mobile communications network service area and the wireless LAN service area in the Internet access service system of FIG. 4.

### DETAILED DESCRIPTION OF THE PREFERRED EMBODIMENTS

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

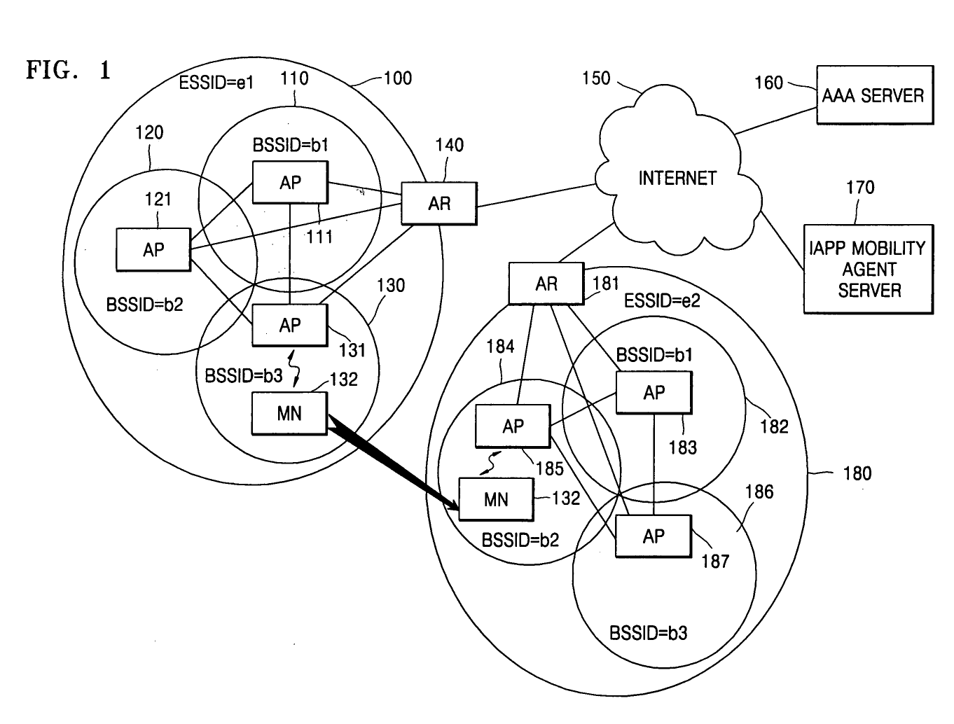

FIG. 1 is a diagram illustrating an exemplary embodiment of a network including an Internet access service system for mobile nodes according to an exemplary embodiment of the present invention. More specifically, FIG. 1 illustrates movements of a mobile node (MN) 132 from a wireless local area network (LAN) service area 100 having an extended service set identifier (ESSID) e1 to a wireless LAN service area 180 having an ESSID e2. It is apparent that all of the devices shown in FIG. 1 may include at least one of a processor, controller, processing module, computing device, or the like to perform operations.

Referring to FIG. 1, the network includes the wireless LAN service area 100, the Internet 150, an AAA server 160, an inter-access point protocol (IAPP) mobility agent server 170, and the wireless LAN service area 180.

The wireless LAN service area 100 includes network service areas 110, 120 and 130, and an access router (AR) 140, which manages the network service areas 110, 120, and 130.

The network service area 110 has a basic service set identifier (BSSID) b1 and is managed by an access point (AP) 111. The network service area 120 has a BSSID b2 and is managed by an AP 121. The network service area 130 has a BSSID b3 and is managed by an AP 131. The APs 111, 121, and 131 may be wireless accessing devices.

In this exemplary embodiment, APs 111, 121, and 131 share information on the MN 132 with one another by multicasting an IAPP message to one another when associated with the MN 132. In this exemplary embodiment, the IAPP message is based on IAPP, which is a protocol standardized in association with the IEEE 802.11f standard.

If the MN 132 attempts to access the Internet 150 from the network service area 130 via the AP 131, the AP 131 accesses the AAA server 160 via the AR 140 and the Internet 150 and then performs authorization, authentication, and accounting processes (hereinafter, referred to as AAA processes) for the MN 132. Once the AAA processes are completed, the AP 131 performs appropriate operations so that the MN 132 can be connected to the Internet 150, and thus can be provided Internet services by an Internet service provider (ISP).

Once the MN 132 is connected to the Internet 150, the AP 131 multicasts an IAPP message, which contains information on the MN 132 obtained by performing the AAA processes, in its network service area 100. Then, the APs 111 and 121 can share the information on the MN 132 with the AP 131 by receiving the IAPP message multicasted from the AP 131. The information on the MN 132 includes an authentication key of the MN 132, ESSD information that specifies an ESSID of a wireless LAN service area 100, to which the MN 132 currently belongs, BSSID information that specifies a BSSID of a network service area 130, to which the MN 132 currently belongs, and accounting information.

If the ISP designates the AP 111 as a representative AP of the wireless LAN service area 100, the AP 111 unicasts a packet containing the IAPP message received from the AP 131 to the IAPP mobility agent server 170 via the AR 140 and the Internet 150. In addition, the AP 111 may receive a packet containing an IAPP message from a representative AP of a service area having a different ESSID from the wireless LAN service area 100 via the IAPP mobility agent server 170.

In order to transmit/receive a packet to/from the IAPP mobility agent server 170, the AP 111 may include a user datagram protocol (UDP) encapsulation module (not shown), a UDP decapsulation module (not shown), and a control module (not shown), which controls the UDP encapsulation and decapsulation modules. In this case, the AP 111 can transmit/receive a UDP packet to/from the IAPP mobility agent server 170.

If the MN 132 moves from the network service area 130 to the network service area 120, the AP 121 multicasts an IAPP message containing the information on the MN 132 throughout the entire wireless LAN service area 100 and updates the location information of the MN 132 shared with the other APs 111, 121 and 131. In this case, since the ESSID information of the MN 132 has not yet been changed, the representative AP, i.e., the AP 111, does not need to unicast the IAPP message to the IAPP mobility agent server 170.

The wireless LAN service area 180 includes network service areas 182, 184, and 186 having different BSSIDs and an AR 181. The network service area 182 has a BSSID b1 and is managed by an AP 183. The network service area 184 has a BSSID b2 and is managed by an AP 185. The network service area 186 has a BSSID b3 and is managed by an AP 187.

The APs 183, 185, and 187, like the APs 111, 121, and 131 in the wireless LAN service area 100, share information on an MN with one another by multicasting an IAPP message throughout the entire wireless LAN service area 180 when associated with the MN.

If the ISP designates the AP 183 as a representative AP of the wireless LAN service area 180, the AP 183, like the AP 111, may transmit/receive a UDP packet containing an IAPP message to/from the IAPP mobility agent server 170. In order to transmit/receive the UDP packet to/from the IAPP mobility agent server 170, the first AP 183 may include a UDP encapsulation module (not shown), a UDP decapsulation module (not shown), and a control module (not shown), which controls the UDP encapsulation and decapsulation modules.

When the IAPP mobility agent server 170 receives a UDP packet containing an IAPP message from an AP via the Internet 150, the IAPP mobility agent server 170 forwards the received UDP packet to a representative AP of a wireless LAN service area having an ESSID different from an ESSID of a wireless LAN service area that the AP belongs to. In other words, the IAPP mobility agent server 170 may forward the received UDP packet to any wireless LAN service areas in a predetermined network service area managed by the ISP with the exception of the wireless LAN service area that the AP belongs to.

Therefore, the IAPP mobility agent server 170 unicasts the UDP packet received from the AP 111 to the AP 183 because the MN 132 is associated with the AP 131 in the wireless LAN service area 100, as shown in FIG. 1.

When the AP 183 receives the UDP packet containing the IAPP message from the IAPP mobility agent server 170, the AP 183 multicasts the IAPP message to the wireless LAN service area 180, and the APs 185 and 187 receives the IAPP message so that they can share the information on the MN 132 with the AP 183.

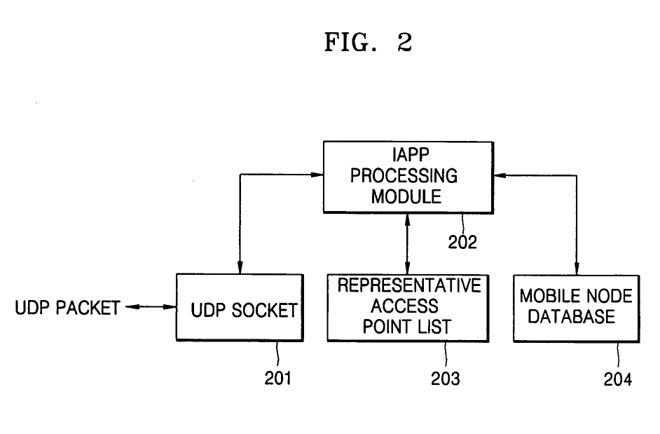

An exemplary embodiment of a structure of the IAPP mobility agent server 170, which enables APs belonging to different network service areas with different ESSIDs to share information on an MN, is illustrated in FIG. 2.

Referring to FIG. 2, the IAPP mobility agent server 170 includes a UDP socket 201, an IAPP processing module 202, a representative AP list 203, and a MN database 204.

The UDP socket 201 receives a UDP packet from an AP and transmits the UDP packet to the AP or another AP via the Internet 150.

The IAPP processing module 202 performs a predetermined operation so that an IAPP message can be shared between APs in different wireless LAN service areas connected to each other by an ISP but having different ESSIDs. Therefore, when a UDP packet is received from the UDP socket 201, the IAPP processing module 202 parses an IAPP message contained in the received UDP packet, thereby obtaining information on the MN 132. The IAPP processing module 202 stores the information on the MN 132 in the MN database 204.

The IAPP processing module 202 designates, as a representative AP, one of a plurality of APs in each of a plurality of wireless LAN service areas managed by the ISP except for a wireless LAN service area, from which the UDP packet has been initially transmitted, by referring to information stored in the representative AP list 203 based on an IP address of the first AP 111, contained in the UDP packet, and forwards the UDP packet to the UDP socket 201 so that the UDP packet can be unicasted to the representative AP. The UDP packet forwarded back to the UDP socket 201 also includes the IAPP message, which contains the information on the MN 132.

The representative AP list 203 stores IP addresses of representative APs in all ESS service areas that can be connected to one another by the ISP.

The MN database 204 stores the information on the MN 132 contained in the IAPP message, such as an authentication key, ESSID and BSSID information, and accounting information of the MN 132, and is updated whenever the MN 132 is associated with a network in a new wireless LAN service area.

Referring back to FIG. 1, as the MN 132 moves from the network service area 130 managed by the AP 131 to the network service area 184 managed by the AP 185, the frequency of the beacon signals received from the AP 131 decreases. If the frequency of beacon signals received from the AP 131 is lower than a predetermined reference value, the MN 132 makes preparations to enter the wireless LAN service area 180. Given all this, the MN 132 may include a module (not shown) for counting the number of beacon signals received from the AP 131 and comparing the number of beacon signals received from the AP 131 with the predetermined reference value.

If the MN 132 issues an association request to the AP 185 as part of the preparations to enter the wireless LAN service area 180, the AP 185 attempts to connect the MN 132 to the Internet 150 while performing an authentication process on the MN 132 based on the information on the MN 132. The AP 185 stores the information on the MN 132, which has been multicasted from the first AP 183. The access router 181 can maintain an Internet service session for the MN 132 by quickly switching the MN 132 from the wireless LAN service area 100 to the wireless LAN service area 180 without accessing the AAA server 160 via the Internet 150 to re-authenticate the MN 132.

When the MN 132 completes its association with the Internet 150, the AP 185 multicasts the IAPP message containing the information on the MN 132 to the wireless LAN service area 180. Accordingly, the APs 183 and 187 receive the IAPP message from the AP 185 and then update information on the MN 132 that is based on the received IAPP message. The representative AP of the wireless LAN service area 180, i.e., the AP 183, unicasts the IAPP message containing the updated information on the MN 132 to the IAPP mobility agent server 170 via the access router 181 and the Internet 150.

The IAPP mobility agent server 170 updates the information on the MN 132 stored in the MN database 204, which contains an IAPP message containing the updated information on the MN 132, and then unicasts a UDP packet to all representative APs except for the AP 183 with reference to information stored in the representative AP list 203.

When the MN 132 completes its association with the first AP 183 while moving from the network service area 184 to the network service area 182, the AP 183 multicasts an IAPP message containing new information on the MN 132 to the wireless LAN service area 180 such that the information on the MN 132 stored in each of the APs 185 and 187 is updated. However, since the ESSID information of the MN 132 has not yet been changed, the AP 183 does not unicast the IAPP message to the IAPP mobility agent server 170.

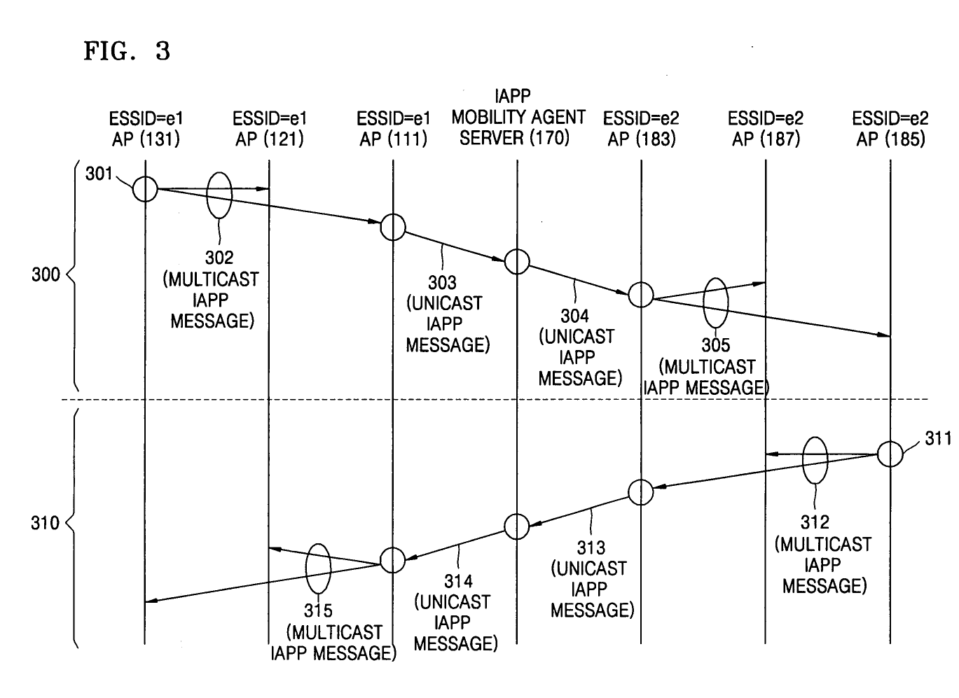

FIG. 3 is a diagram illustrating an exemplary embodiment of the transmission of an IAPP message between the wireless LAN service area 100 and the wireless LAN service area 180 via the IAPP mobility agent server 170. More specifically, an upper half 300 of FIG. 3 illustrates a case where the MN 132 is associated with the Internet 150 in the network service area 130 managed by the AP 131, and an IAPP message containing information on the MN 132 is forwarded to the wireless LAN service area 100 having the ESSID e1 and to the wireless LAN service area 180 having the ESSID e2. A lower half 310 of FIG. 3 illustrates a case where the MN 132 is associated with the Internet 150 in the network service area 184 managed by the AP 185, and an IAPP message containing information on the MN 132 is forwarded to the wireless LAN service area 180 having the ESSID e2 and to the wireless LAN service area 100 having the ESSID e1.

In the upper half 300 of FIG. 3, the MN 132 is associated with the Internet 150 in the network service area 130 managed by the AP 131(301). Then, the AP 131 multicasts an IAPP message to the wireless LAN service area 100 such that the APs 111 and 121 having the same ESSID (e1) as the AP 131 receive the IAPP message from the AP 131(302).

As described above with reference to FIG. 1, the AP 111, which is the representative AP of the wireless LAN service area 100, unicasts the IAPP message to the IAPP mobility agent server 170 (303). The IAPP mobility agent server 170 unicasts the IAPP message to the AP 183, which is the representative AP of the wireless LAN service area 180 (304).

The AP 183 multicasts the IAPP message to the wireless LAN service area 180 such that the APs 185 and 187 in the wireless LAN service area 180 may possess the information on the MN 132, which is currently being associated with the Internet in the wireless LAN service area 100 (305).

In the lower half 310 of FIG. 3, the MN 132 is associated with the Internet 150 in the wireless LAN service area 184 managed by the AP 185 (311). Then, the AP 185 multicasts the IAPP message to the wireless LAN service area 180 such that the APs 183 and 187 having the same ESSID e2 as the AP 185 receive the IAPP message.

As described above with reference to FIG. 1, the AP 183, which is the representative AP of the wireless LAN service area 180 having the ESSID e2, unicasts the IAPP message to the IAPP mobility agent server 170 (313). The IAPP mobility agent server 170 unicasts the IAPP message to the AP 111, which is the representative AP of the wireless LAN service area 100 (314).

The AP 111 multicasts the IAPP message to the wireless LAN service area 100 (315) so that the APs 121 and 131 can possess the information on the MN 132, which is currently being associated with the Internet 150 in the wireless LAN service area 180.

When the MN 132 moves to the network service area 184 managed by the AP 185, an authentication process is performed on the MN 132 based on information on the MN 132 possessed by the AP 185. The association of the MN 132 with the Internet 150 is complete, and then the operation illustrated in the lower half 310 of FIG. 3 may be performed. Accordingly, information on the MN 132 stored in the MN database 204 of the IAPP mobility agent server 170 and information on the MN 132 shared by all the APs managed by the ISP are updated. In other words, location information of the MN 132 is updated in accordance with the movement of the MN 132 from the network service area 130 with the ESSID e1 to the network service area 184 with the ESSID e2.

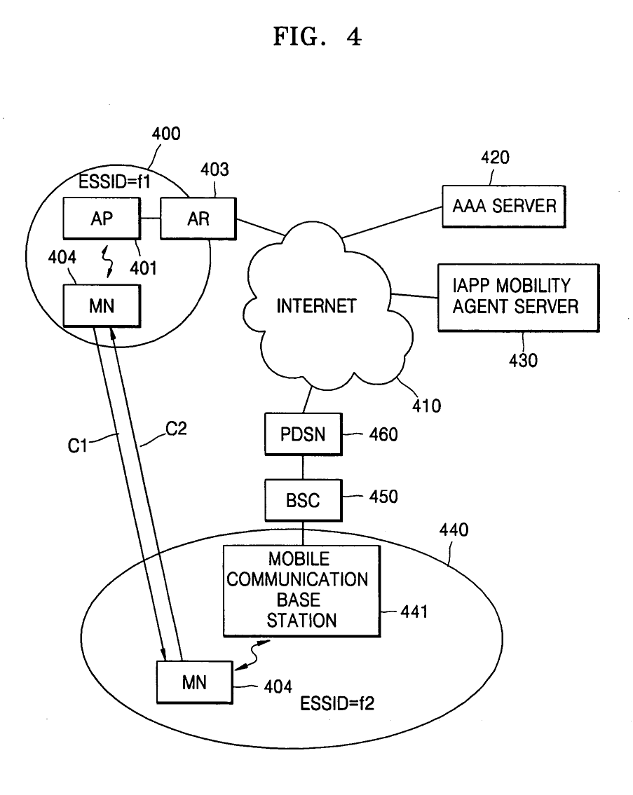

FIG. 4 is a diagram illustrating an exemplary embodiment of a network including an Internet access service system for MNs according to another exemplary embodiment of the present invention. More specifically, FIG. 4 illustrates an exemplary embodiment where a MN moves between a wireless LAN service area 400 having an ESSID f1 and a mobile communications network service area 440 having an ESSID f2. It is apparent that all of the devices shown in FIG. 4 may include at least one of a processor, controller, processing module, computing device, or the like to perform operations.

Referring to FIG. 4, the network includes the wireless LAN service area 400, the Internet 410, an AAA server 420, an IAPP mobility agent server 430, the mobile communications network service area 440, a packet data service node (PDSN) 460, and a base station controller 450.

In the wireless LAN service area 400, an access router 403 manages a network service area of an AP 401. However, the wireless LAN service area 400 may have the same structure as each of the wireless LAN service areas 100 and 180 of FIG. 1. The access router 403 may have the same structure as each of the ARs 140 and 181 of FIG. 1. The AP 401 may have the same structure as each of the representative APs 111 and 183 of FIG. 1.

The IAPP mobility agent server 430, which has the same structure as the IAPP mobility agent server 170 of FIG. 2, allows APs in different network service areas having different ESSIDs to share information on a MN and manages the information on the MN. Even though the IAPP mobility agent server 430, (unlike the IAPP mobility agent server 170 of FIG. 1, which mediates the wireless LAN service areas 100 and 180 having different ESSIDs), mediates the wireless LAN service area 400 and the mobile communications network service area 440 having different ESSIDs, the IAPP mobility agent server 430 may have the same structure and operate in the same manner as the IAPP mobility agent server 170, such that the information on the MN 404 can be shared across APs in each of the wireless LAN service area 400 and the mobile communications network service area 440.

In this exemplary embodiment, the MN 404 issues an association request to the AP 401 using a wireless LAN service. Then, the AP 401 performs an authentication process on the MN 404 by communicating with the AAA server 420. Once the authentication process is completed such that the MN 404 can be provided an Internet service via the AP 401, the AP 401 UDP-packetizes an IAPP message containing the information on the MN 404. Then, the AP 401 unicasts the UDP-packetized IAPP message to the IAPP mobility agent server 430 via the access router 403 and the Internet 410. In order to packetize the IAPP message and then unicast the UDP-packetized IAPP message to the IAPP mobility agent server 430, the AP 401 may include a UDP encapsulation module (not shown), a UDP decapsulation module (not shown), and a control module (not shown), which controls the UDP encapsulation and decapsulation modules.

When the IAPP mobility agent server 430 receives the UDP-packetized IAPP message, it forwards the UDP-packetized IAPP message to a representative AP of a network service area having an ESSID different from the AP 401 by referring to the representative AP list 203 of FIG. 2. IP information stored in the representative AP list 203 includes an IP address of the PDSN 460. The PDSN 460 is classified as a network service area having an ESSID different from the AP 401. An ISP can allot a unique ESSID to the PDSN 460 so that the PDSN 460 can be differentiated from the other network service areas.

Thereafter, the IAPP mobility agent server 430 unicasts the UDP-packetized IAPP message to the PDSN 460 via the Internet 410.

An IP is used between the PDSN 460 and the Internet 410. The PDSN 460 and the base station controller 450 communicate with each other via a mobile communication protocol defined by the ISP, and the base station controller 450 and a mobile communication base station 441 also communicate with each other via the mobile communication protocol. The PDSN 460, the base station controller 450, and the mobile communication base station 441 are all electronically connected to each other. Therefore, in order to forward an IAPP message to a virtual AP (not shown) installed in the mobile communication base station 441, a point-to-point (PPP) protocol session is opened on the mobile communication protocol, which operates between the PDSN 460 and the virtual AP, so that the PDSN 460 and the virtual AP can be PPP-connected to each other. Accordingly, the PDSN 460 can forward a UDP packet containing the IAPP message to the virtual AP in the mobile communication base station 441 by using its PPP-connection to the virtual AP.

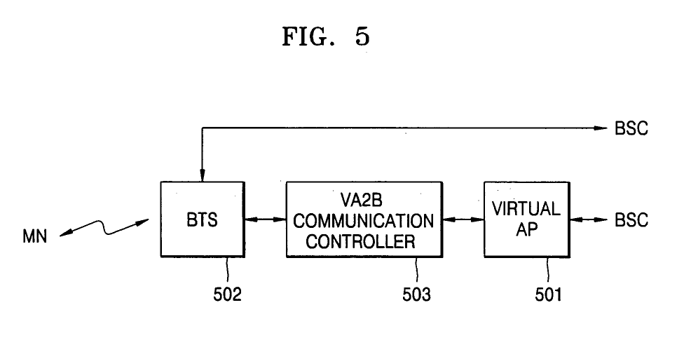

The mobile communication base station 441 manages the mobile communications network service area 440. A structure of an exemplary embodiment of the mobile communication base station 441 is illustrated in FIG. 5. Referring to FIG. 5, the mobile communication base station 441 includes a virtual AP 501 (VIRTUAL AP), a base transceiver station 502 (BTS), and a virtual AP-to-base transceiver station communication controller 503 (VA2B COMMUNICATION CONTROLLER).

The virtual AP 501 is connected to the Internet 410 via the PDSN 460, which is PPP-connected to the mobile communication base station 441. When a UDP packet containing an IAPP message is received from the PDSN 460 via the base station controller 450, the virtual AP 501 performs an IAPP operation by removing a PPP header from the UDP packet, parsing resulting UDP packet data, and then storing the parsed UDP packet data. Accordingly, the mobile communications network service area 440 and the wireless LAN service area 400 can share the same information on the MN 404.

The base transceiver station 502 provides a path, along which the mobile communication base station 441 can wirelessly communicate with the MN 404. The base transceiver station 502 operates by using a protocol exclusive for a mobile communications network.

The virtual AP-to-base transceiver station communication controller 503 is a module for enabling the base transceiver station 502 to communicate with the virtual AP 501. The virtual AP-to-base transceiver station communication controller 503 is necessary because the virtual AP 501, unlike the base transceiver station 502, which operates by using the protocol exclusive for a mobile communications network, operates using an IP.

As illustrated in FIG. 4, when moving from the wireless LAN service area 400 to the mobile communications network service area 440, the MN 404 issues an association request to the mobile communication base station 441. Then, the base transceiver station 502 in the mobile communication base station 441 issues a request for authentication information on the MN 404 to the virtual AP-to-base transceiver station communication controller 503 by using the intrinsic information of the MN 404, such as terminal identification information.

The virtual AP-to-base transceiver station communication controller 503 issues a request for the authentication information on the MN 404 to the virtual AP 501 by using the intrinsic information of the MN 404. Then, the virtual AP 501 determines whether it possesses the requested authentication information on the MN 404 by referring to the intrinsic information of the MN 404. If the virtual AP 501 possesses the requested authentication information on the MN 404, it provides the requested authentication information on the MN 404 to the virtual AP-to-base transceiver station communication controller 503. Otherwise, the virtual AP 501 provides information indicating that it has failed to search for the requested authentication information on the MN to the virtual AP-to-base transceiver station communication controller 503.

The virtual AP-to-base transceiver station communication controller 503 transmits information received from the virtual AP 501 to the base transceiver station 502. The base transceiver station 502 determines whether to perform an authentication process on the MN 404 based on the information received from the virtual AP-to-base transceiver station communication controller 503. If the base transceiver station 502 receives the requested authentication information on the MN 404 from the virtual AP-to-base transceiver station communication controller 503, it performs an authentication process on the MN 404 by using the requested authentication information on the MN 404. Thereafter, the base transceiver station 502 issues a request for PPP-connecting the MN 404 to the PDSN 460 to the PDSN 460 via the base station controller 450 without the need to further issue a request for authenticating the MN 404 to the PDSN 460.

However, if the base transceiver station 502 does not receive the requested authentication information on the MN 404 from the virtual AP-to-base transceiver station communication controller 503, the base transceiver station 502 issues the request for authenticating the MN 404 as well as the request for PPP-connecting the MN 404 to the PDSN 460 to the base station controller 450. Accordingly, the PDSN 460 communicates with the AAA server 420, thereby performing AAA processes on the MN 404. Eventually, the PDSN 460 and the MN 404 are PPP-connected to each other.

FIG. 4 illustrates an exemplary embodiment of a network including only one wireless LAN service area (400) and only one mobile communications network service area (440). However, the present invention can also be applied to an expanded version of the network, i.e., a network comprising a plurality of wireless LAN service areas and a plurality of mobile communications network service areas.

In addition, FIG. 4 only illustrates an occasion C1 when the MN 404 moves from the wireless LAN service area 400 to the mobile communications network service area 440. However, the present invention can also be applied to the opposite of the occasion C1, i.e., an occasion C2 when the MN 404 moves from the mobile communications network service area 440 to the wireless LAN service area 400. In the occasion C2, the wireless LAN service area 400 and the mobile communications network service area 440 are enabled to share the information on the MN 404 by performing the above-described IAPP processes in the inverse order of their presentation above.

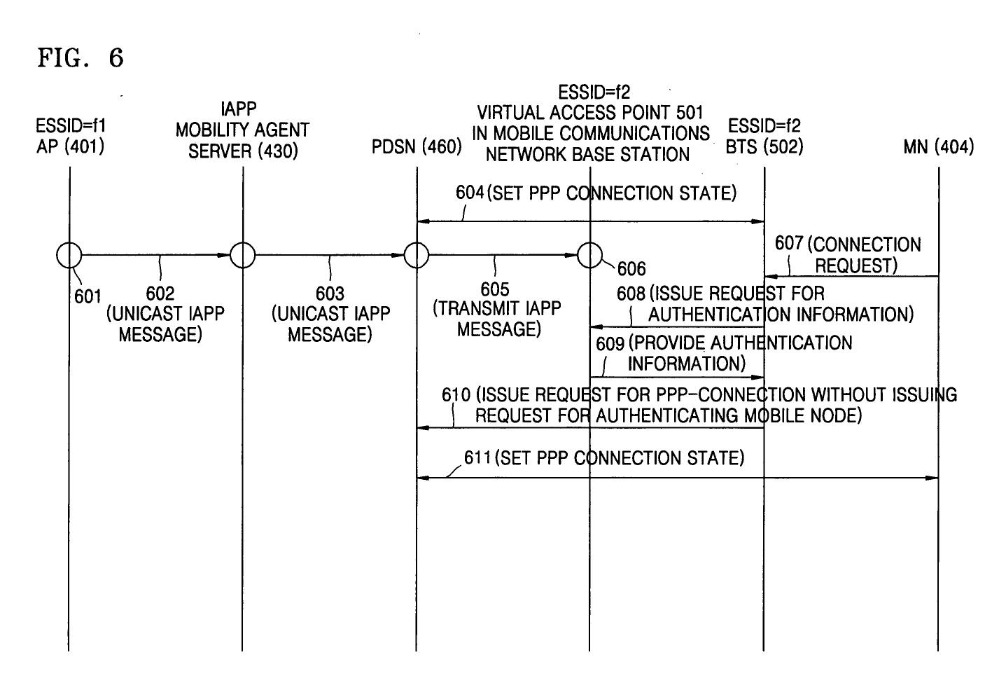

FIG. 6 is a diagram illustrating an exemplary embodiment where the MN 404 is associated with the AP 401, which is a representative AP of the wireless LAN service area 400 having the ESSID f1, and the AP 401 forwards an IAPP message to the virtual AP 501 of the mobile communication base station 441 in the mobile communications network service area 440 via the IAPP mobility agent server 430.

Referring to FIG. 6, when the MN 404 is associated with the AP 401 to use an Internet service (601), the AP 401 UDP-packetizes an IAPP message containing information on the MN 404 and unicasts the UDP-packetized IAPP message to the IAPP mobility agent server 430 (602). The IAPP mobility agent server 430 unicasts the UDP-packetized IAPP message to the PDSN 460 (603). As described above, the PDSN 460, the base station controller 450, and the virtual AP 501 are all PPP-connected to each other (604).

The PDSN 460 forwards the UDP-packetized IAPP message to the virtual AP 501 via its PPP connection to the virtual AP 501 (605). The virtual AP 501 parses the UDP-packetized IAPP message and then stores authentication information on the MN 404 (606).

When moving from the wireless LAN service area 400 to the mobile communications network service area 440, the MN 404 issues an association request to the base transceiver station 502 (607). The base transceiver station 502 issues a request for the authentication information on the MN 404 to the virtual AP 501 (608) by using the intrinsic information of the MN 404.

The virtual AP 501 determines whether it possesses the requested authentication information on the MN 404 by referring to the intrinsic information of the MN 404. If the virtual AP 501 possesses the requested authentication information on the MN 404, it provides the requested authentication information on the MN 404 to the base transceiver station 502 (609). The base transceiver station 502 performs an authentication process on the MN 404 by using the requested authentication information on the MN 404 and issues a request for PPP-connecting the MN 404 to the PDSN 460 to the PDSN 460 (610) without further issuing a request for authenticating the MN 404 to the PDSN 460. Accordingly, the MN 404 is PPP-connected to the PDSN 460 (611) without being authenticated by the PDSN 460.

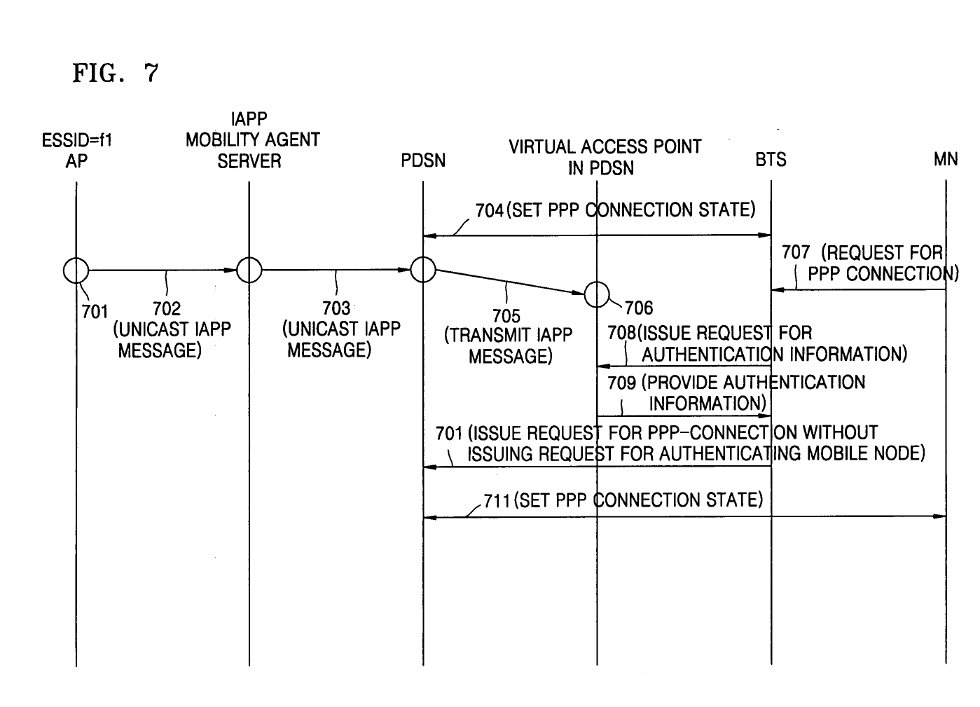

FIG. 7 is a diagram illustrating an exemplary embodiment where the MN 404 is associated with the AP 401 in the wireless LAN service area 400 and the AP 401 forwards an IAPP message to the mobile communication network service area 440 having a different ESSID from the wireless LAN service area 400 via the IAPP mobility agent server 430. In FIG. 7, unlike in FIG. 6, a virtual AP is installed in the PDSN 460 rather than in the mobile communication base station 441, thereby establishing a mobile communication network. Accordingly, an IAPP message forwarded from the IAPP mobility agent server 430 is stored in the virtual AP in the PDSN 460 (706) without the need to forward the IAPP message to the base transceiver station 502.

When moving to a network service area managed by the base transceiver station 502, the MN 404 issues an association request to the base transceiver station 502 (707). Then, the base transceiver station 502 issues a request for authentication information on the MN 404 to the virtual AP in the PDSN 460 via its PPP-connection to the PDSN 460 (708). If the base transceiver station 502 receives the requested authentication information on the MN 404 from the virtual AP in the PDSN 460 (709), it performs an authentication process on the MN 404 by using the authentication information on the MN 404 and issues a request for PPP-connecting the MN 404 to the PDSN 460 to the PDSN 460 (710) without further issuing a request for authenticating the MN 404.

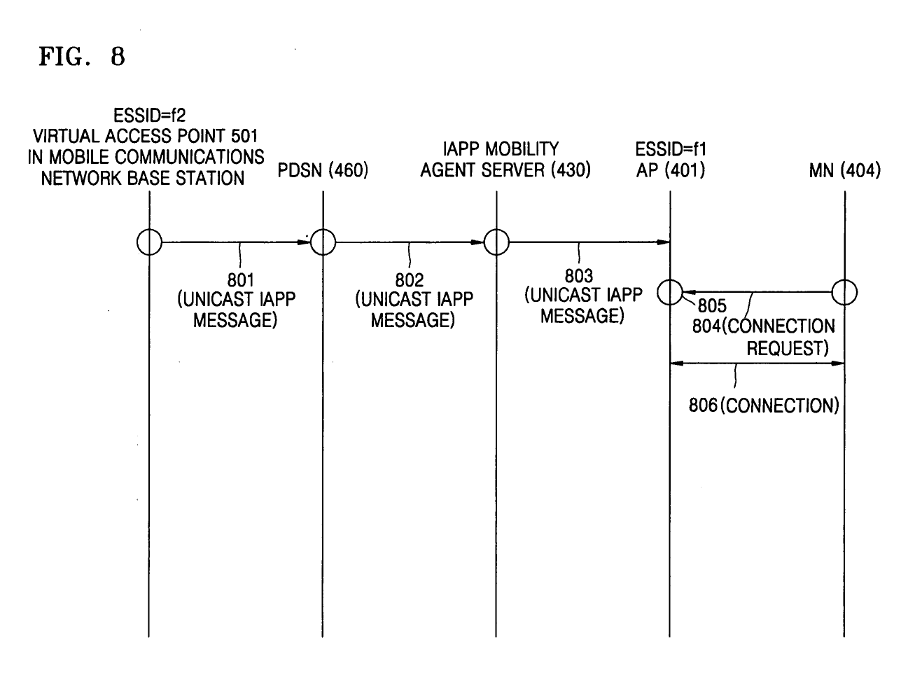

FIG. 8 is a diagram illustrating an exemplary embodiment of occasion C2 when the MN 404 moves from the mobile communications network service area 440 to the wireless LAN service area 400. Referring to FIG. 8, the virtual AP 501 in the mobile communication base station 441 transmits an IAPP message containing authentication information on the MN 404 to the AP 401 (801, 802, and 803), which is the representative AP of the wireless LAN service area 400 having the ESSID f1. The AP 401 performs an authentication process (805) on the MN 132, which has entered the wireless LAN service area 400 managed by the AP 401, in response to an association request issued by the MN 404. The MN 404 is connected to the AP 401 (806).

As described above, according to the present invention, an IAPP message can be transmitted between network service areas having different ESSIDs or between a network service area and a mobile communications network service area having different ESSIDs. Therefore, AAA processes are only performed on a MN at an early stage of connecting the MN to the Internet, and the MN is switched between different types of network service areas or between network service areas having different ESSIDs without re-authenticating the MN. Thus, it is possible to reduce the amount of time taken to switch the MN between the different types of network service areas or between the network service areas having different ESSIDs.

In addition, the location of the MN can, at any time, be managed by using a single agent regardless of the type of network to which the MN currently belongs. Thus, it is possible to maximize the ease with which the location of the MN is managed.

Moreover, even when the MN moves between different types of network service areas, a single ISP enables the different types of network service areas to share and use authentication information on the MN. Accordingly, it is possible to simplify the AAA processes. In addition, it is possible to quickly switch the MN between the network service areas and minimize data loss and the frequencies of discontinuities in an Internet service connection for the MN.

Furthermore, since in the present invention, the MN is switched between a wireless LAN service area and a mobile communications network service area in the same manner as it is switched between different wireless LAN service areas having different ESSIDs, it is possible to quickly perform an Internet re-association operation and minimize the number of packets unnecessarily used during a bicasting operation.

In addition, the Internet connection service methods according to the exemplary embodiments of the present invention may be written as a computer program so that they are executed in a common digital computer or any other computing device such as a mobile node. The computer program may be stored in a computer-readable data storage medium so that it is read and executed by a computer or any other computing device. Examples of the computer-readable data storage medium include a magnetic recording medium (e.g., a ROM, a floppy disc, or a hard disc), an optical recording medium (e.g., a CD-ROM or a DVD), and a carrier wave medium or digital transmission medium (e.g., data transmission through the Internet). Examples of the computer-readable data storage medium further include any type of transmission medium including networks, which may be wired networks, wireless networks or any combination thereof. The computer-readable data storage medium may be referred to as a medium, and the medium may be distributed among computing devices as part of one or more networks or coupled with one or more networks.

Although a few exemplary embodiments of the present invention have been shown and described, it would be appreciated by those skilled in the art that changes may be made in these exemplary embodiments without departing from the principles, spirit, and scope of the invention, the scope of which is defined in the claims and their equivalents.

1. An Internet connection service method for a mobile node comprising:
receiving an inter-access point protocol (IAPP) message including authentication information on the mobile node from an access point (AP) of a network service area, to which the mobile node currently belongs; and
transmitting the IAPP message to an AP of at least one network service area having different identification information from the network service area, to which the mobile node currently belongs.

2. The Internet access service method of claim 1, wherein the APs are representative APs of their respective network service areas.

3. The Internet access service method of claim 2, wherein if any of the network service areas are mobile communications network service areas, the representative APs of the mobile communications network service areas are virtual APs.

4. The Internet access service method of claim 1, wherein the network service areas are wireless LAN service areas or mobile communications network service areas.

5. The Internet access service method of claim 1, wherein the network service areas are connected to each other by one Internet service provider (ISP).

6. An Internet connection service method for a mobile node comprising:
enabling a representative access point (AP) of a first network service area to transmit an inter-AP protocol message (IAPP) message containing authentication information on the mobile node to an IAPP mobility agent server on the Internet if the mobile node is connected to the first network service area;
enabling the IAPP mobility agent server to transmit the IAPP message to a representative AP of at least one network service area having different identification information from the first network service area;
enabling the representative AP of the at least one network service area to multicast the IAPP message to at least one AP in the at least one network service area; and
enabling a first AP in a second network service area among the at least one network service area to perform an authentication process on the mobile node by referring to the IAPP message and to connect the mobile node to the Internet if the mobile node moves to a service area managed by the first AP.

7. The Internet access service method of claim 6, wherein the first network service area and the at least one network service area are wireless LAN service areas or mobile communications network service areas.

8. The Internet access service method of claim 6, wherein the first network service area and the at least one network service area are connected to each other by an ISP.

9. An IAPP mobility agent server used in an Internet connection service system for a mobile node, the IAPP mobility agent server comprising a processing module, which enables APs in wireless LAN service areas and/or mobile communication service areas having different identification information to share an IAPP message containing authentication information on the mobile node, the wireless LAN service areas and/or the mobile communication service areas are connected to one another by an ISP.

10. The IAPP mobility agent server of claim 9 further comprising:
a first storage unit, which stores Internet protocol (IP) addresses of the APs,
wherein the APs are representative APs of their respective network service areas.

11. The IAPP mobility agent server of claim 10 further comprising:
a second storage unit, which stores the authentication information on the mobile node, included in the IAPP message.

12. The IAPP mobility agent server of claim 9 further comprising:
a second storage unit, which stores the authentication information on the mobile node, included in the IAPP message.

13. The IAPP mobility agent server of claim 12, wherein the authentication information on the mobile node, which is stored in the second storage unit, is updated whenever the mobile node completes its association with the Internet.

14. A mobile communication base station used in an Internet connection service system for a mobile node, the mobile communication base station comprising:
a virtual AP, which is connected to the Internet via a packet data service node (PDSN) and performs an inter-AP protocol operation, the PDSN being connected to a mobile communications network;
a base transceiver station, which is wirelessly connected to the mobile node; and
a communication controller, which obtains authentication information on the mobile node from the virtual AP, and then provides the authentication information on the mobile node to the base transceiver station if the base transceiver station issues a request for the authentication information on the mobile node.

15. The mobile communication base station of claim 14, wherein the base transceiver station determines whether to perform an authentication process on the mobile node based on information transmitted from the communication controller in response to the request for the authentication information on the mobile node.

16. The mobile communication base station of claim 14, wherein when the mobile node is connected to the base transceiver station, the virtual AP transmits an IAPP message containing the authentication information on the mobile node to the PDSN.

17. A mobile communication base station used in an Internet connection service system for a mobile node, the mobile communication base station comprising:
a virtual AP, which is installed in a PDSN and performs an inter-AP protocol operation by using the Internet;
a base transceiver station, which is wirelessly connected to the mobile node; and
a communication controller, which obtains authentication information on the mobile node from the virtual AP and then provides the authentication information on the mobile node to the base transceiver station if the base transceiver station issues a request for the authentication information on the mobile node.

18. An Internet connection service system for mobile nodes comprising:
a first AP, which transmits an inter-AP protocol (IAPP) message to the Internet if a mobile node is connected to the Internet in a first network service area;
a second AP, which has a different extended service set identifier (ESSID) from the first AP, receives and stores the IAPP message, and performs an authentication process on the mobile node by referring to the IAPP message stored therein if the mobile node moves to a second network service area; and
an IAPP mobility agent server, which receives the IAPP message from the first AP and then transmits the IAPP message to a representative AP of at least one network service area other than the first network service area.

19. The Internet access service system of claim 18, wherein the first and second APs are representative APs of the first and second network service areas.

20. The Internet access service method of claim 1, wherein the IAPP message from the mobile node is received by an IAPP mobility agent server, and the IAPP mobility agent server transmits the IAPP message to the AP of at least one network service area having the different identification information from the network service area, to which the mobile node currently belongs.

21. At least one computer readable medium storing instructions that control at least one processor to perform a method comprising:
receiving an inter-access point protocol (IAPP) message including authentication information on a mobile node from an access point (AP) of a network service area, to which the mobile node currently belongs; and
transmitting the IAPP message to an AP of at least one network service area having different identification information from the network service area, to which the mobile node currently belongs.

22. The medium of claim 21, wherein the APs are representative APs of their respective network service areas.

23. The medium of claim 22, wherein if any of the network service areas are mobile communications network service areas, the representative APs of the mobile communications network service areas are virtual APs.

24. The medium of claim 21, wherein the network service areas are wireless LAN service areas or mobile communications network service areas.

25. The medium of claim 21, wherein the network service areas are connected to each other by one Internet service provider (ISP).

26. At least one computer readable medium storing instructions that control at least one processor to perform a method comprising:
enabling a representative access point (AP) of a first network service area to transmit an inter-AP protocol message (IAPP) message containing authentication information on a mobile node to an IAPP mobility agent server on the Internet if the mobile node is connected to the first network service area;
enabling the IAPP mobility agent server to transmit the IAPP message to a representative AP of at least one network service area having different identification information from the first network service area;
enabling the representative AP of the at least one network service area to multicast the IAPP message to at least one AP in the at least one network service area; and
enabling a first AP in a second network service area among the at least one network service area to perform an authentication process on the mobile node by referring to the IAPP message and to connect the mobile node to the Internet if the mobile node moves to a service area managed by the first AP.

27. The medium of claim 26, wherein the first network service area and the at least one network service area are wireless LAN service areas or mobile communications network service areas.

28. The medium of claim 26, wherein the first network service area and the at least one network service area are connected to each other by an ISP.

29. A network for connecting a mobile node to the network, comprising:
an authorization, authentication, and accounting (AAA) server coupled to the Internet;
an inter-access point protocol (IAPP) mobility agent server coupled to the Internet; and
a plurality of network service areas coupled to the Internet, wherein:
the mobile node initiates a request for access to the Internet through a first network service area, which accesses the AAA server through the Internet,
the AAA server processes the request and permits the mobile node to connect to the Internet;
the first network service area transmits an IAPP message providing information on the mobile node to the IAPP mobility agent server;
the mobile node moves from the first network service area to a second network service area with uninterrupted access to the Internet, and without accessing the AAA server.

30. The network of claim 29, wherein the second network service area transmits another IAPP message providing updated information on the mobile node to the IAPP mobility agent server.

31. The network of claim 29, wherein the first network service area is a wireless local area network (LAN) service area or a mobile communication base station.

32. The network of claim 29, wherein the second network service area is a wireless LAN service area or a mobile communication base station.
